(19) United States
(12) Patent Application Publication
(10) Pub. No.: US 2018/0059464 A1
(43) Pub. Date: Mar. 1, 2018

(54) ELECTRO-OPTICAL DEVICE, ELECTRONIC APPARATUS, AND CONTROL METHOD OF ELECTRO-OPTICAL DEVICE

(71) Applicant: SEIKO EPSON CORPORATION, Tokyo (JP)

(72) Inventors: Akira ASAUMI, Matsumoto-shi (JP); Nariya TAKAHASHI, Chino-shi (JP)

(73) Assignee: SEIKO EPSON CORPORATION, Tokyo (JP)

(21) Appl. No.: 15/689,554

(22) Filed: Aug. 29, 2017

(30) Foreign Application Priority Data
Sep. 1, 2016 (JP) 2016-170559

(51) Int. Cl. G02F 1/1345; G09G 3/36

(52) U.S. Cl. CPC G02F 1/13452; G09G 3/3688; G09G 2320/0252; G09G 3/3696; G09G 3/3648

(57) ABSTRACT

An electro-optical device includes an electro-optical panel in which a first pixel group and a second pixel group configured by a pixel, and a driving circuit are provided, a first circuit that can output the first data signal and a timing signal for controlling the driving circuit to the electro-optical panel, and a second circuit that can output the second data signal and the timing signal to the electro-optical panel, in which during one horizontal scanning period during which writing to the pixel connected to at least one scan line is performed, the number of times that the first circuit outputs the timing signal in a state where the second circuit stops outputting the timing signal, is controlled to be equal to the number of times that the second circuit outputs the timing signal in a state where the first circuit stops outputting the timing signal.

### BACKGROUND

### 1. Technical Field

The present invention relates to an electro-optical device, an electronic apparatus, and a control method of an electro-optical device.

### 2. Related Art

As one aspect of the electro-optical device, a liquid crystal apparatus including an active drive type liquid crystal panel and a flexible printed circuit (hereinafter, referred to as FPC) on which a driving circuit for driving the liquid crystal panel is mounted is known (JP-A-2011-112666). In this liquid crystal apparatus, for example, a semiconductor integrated circuit (hereinafter, referred to as integrated circuit) such as an integrated circuit (IC) chip as a data line driving circuit is mounted on the FPC by a technology referred to as a chip on film (COF). In addition, a technology for driving one liquid crystal panel by using a plurality of FPCs on which the integrated circuit is mounted is disclosed.

There are many cases where the active drive type liquid crystal panel includes a plurality of scan lines and a plurality of data lines, and is provided with a pixel circuit in accordance with an intersection of the scan line and the data line. In addition, in the liquid crystal panel displaying a high-definition image, an interval between the data lines becomes narrow due to an arrangement pitch of the pixels. In a case where the data line driving circuit is provided outside the liquid crystal panel, a pitch of an input terminal for supplying a data signal to each data line becomes narrow and thus a short circuit between the input terminals becomes a problem. Therefore, there is a case where a distribution circuit for supplying a data signal supplied to one input terminal to any one of k data lines (k is arbitrary natural number) according to a timing signal is provided.

In such a liquid crystal apparatus, it is considered that the data line driving circuit mounted on the FPC has a function of supplying the timing signal to the liquid crystal panel, in addition to supplying the data signal to the liquid crystal panel. In this case, the timing signal is supplied to the distribution circuit through an internal wire of the liquid crystal panel, but parasitic capacitance is present in the wire. Accordingly, the timing signal is output to a capacitive load.

As described in JP-A-2011-112666, in a case where one liquid crystal panel is driven by using a plurality of data line driving circuits, the timing signal is generally supplied from one of the plurality of data line driving circuits to the liquid crystal panel.

On the other hand, as described above, since the timing signal is output to the capacitive load, it is necessary to use a transistor with a high driving performance for an output stage of the timing signal in the data line driving circuit. Accordingly, electric power required for outputting the timing signal is not small by the data line driving circuit, the load on the data line driving circuit that outputs the timing signal increases as compared with the data line driving circuit that does not output the timing signal, and the amount of heat generation also increases.

Since a transistor configuring the data line driving circuit is an element of which input/output characteristics have changed depending on temperature, there is a problem that a difference occurs in the output characteristics of the data signal, that is, a difference in gradation to be displayed is caused between the data line driving circuit that supplies the data signal and the timing signal to the liquid crystal panel and another data line driving circuit that supplies only data signal to the liquid crystal panel.

For such a problem, for example, in JP-A-2015-232590, a technology in which by switching the data line driving circuit that outputs the timing signal for each horizontal period, a driving load of the timing signal of each data line driving circuit is equalized during a plurality of horizontal scanning periods is disclosed. With this, it is possible to reduce difference in the amount of generated heat between the data line driving circuits and to reduce the difference in output characteristics between the data line driving circuits.

In the electro-optical device of JP-A-2015-232590, when focusing one horizontal scanning period, a driving load of a timing signal of each data line driving circuit is not equalized. For this reason, there is a concern that great difference occurs in the amount of generated heat between the data line driving circuits, and an effect of reducing the difference in the output characteristics of a data signal according to the amount of generated heat cannot be obtained. That is, for example, there was a problem that cyclic luminance unevenness occurs due to the difference in the output characteristics of the data signal between the data line driving circuits when displaying the same uniform gradation over the entire screen.

### SUMMARY

The invention can be realized in the following aspects or application examples.

### Application Example 1

According to this application example, there is provided an electro-optical device including: an electro-optical panel in which a first pixel group and a second pixel group configured by a pixel corresponding to an intersection of a data line and a scan line, and a driving circuit for writing a first data signal to the first pixel group and writing a second data signal to the second pixel group are provided; a first circuit that can output the first data signal and a timing signal for controlling the driving circuit to the electro-optical panel; and a second circuit that can output the second data signal and the timing signal to the electro-optical panel, in which during one horizontal scanning period during which writing to the pixel connected to at least one scan line is performed, the number of times that the first circuit outputs the timing signal in a state where the second circuit stops outputting the timing signal is equal to the number of times that the second circuit outputs the timing signal in a state where the first circuit stops outputting the timing signal.

According to this application example, during one horizontal scanning period during which writing to the pixel connected to at least one scan line is performed, it is possible to equalize driving loads of the timing signals of the first circuit and the second circuit. With this, for example, if the first circuit and the second circuit are the data line driving circuit, it is possible to reduce the difference in the amount of generated heat of each data line driving circuit compared to the related art. Accordingly, it is possible to reduce the difference in the output characteristics between the respective data line driving circuits, and it is possible to provide an electro-optical device of which visibility of luminance unevenness is reduced.

In this embodiment, for example, the “driving circuit” may be a distribution circuit (demultiplexer), and the first circuit and the second circuit may be the data line driving circuit. In addition, in a case where the “driving circuit” is the distribution circuit (demultiplexer), the “timing signal” may be a selection signal for operating the distribution circuit (demultiplexer).

### Application Example 2

In the electro-optical device according to the application example, it is preferable that the first circuit output the timing signal to the first pixel in the first pixel group, and the first data signal corresponding to the first pixel be written to the first pixel, the first data signal corresponding to the second pixel be written to the second pixel adjacent to the first pixel in the first pixel group in a first direction parallel with or orthogonal to the scan line in a state where the first circuit stops outputting the timing signal, and the first data signal corresponding to a third pixel be written to the third pixel adjacent to the first pixel in the first pixel group in a direction opposite to the first direction in the state where the first circuit stops outputting the timing signal.

According to the application example, for example, when the full-screen same gradation is displayed, it is possible to prevent the pixels to which the data signal of which characteristics have changed due to the driving load of the timing signal is written, from being adjacent to each other. As a result, since it is possible to arrange the pixel to which the data signal of which characteristics have changed by being distributed within a screen is written, it is possible to reduce the difference of average values of the luminance for a partial region within the screen. That is, visibility of luminance unevenness is further reduced.

### Application Example 3

In the electro-optical device according to the application example, it is preferable that the electro-optical panel include a first terminal to which the timing signal is supplied from the first circuit, a second terminal to which the timing signal is supplied from the second circuit, and a wire that electrically connects the first terminal, the second terminal, and the driving circuit to one another.

According to the application example, a path for transmitting the timing signal that is input from the first circuit to the electro-optical panel through the first terminal to the driving circuit, and a path for transmitting the timing signal that is input from the second circuit to the electro-optical panel through the second terminal to the driving circuit are electrically connected to each other by the wire within the electro-optical panel.

With this, it is possible to realize a configuration in which if the timing signal is output from one of the first circuit and the second circuit, the timing signal is supplied to the driving circuit inside the electro-optical panel by using a simple wire inside the electro-optical panel.

### Application Example 4

In the electro-optical device according to the application example, it is preferable that the driving circuit include a first selection circuit that outputs the first data signal to one data line selected among N (N is a natural number equal to or greater than two) data lines belonging to the first pixel group based on the timing signal, and a second selection circuit that outputs the second data signal to one data line selected among N data lines belonging to the second pixel group based on the timing signal.

According to the application example, the driving circuit within the electro-optical panel functions as a so-called demultiplexer, the first circuit and the second circuit function as a so-called data line driving circuit.

With this, it is possible to simplify a configuration of terminals that electrically connect the first circuit, the second circuit, and the electro-optical panel.

### Application Example 5

According to the application example, it is preferable that the electro-optical device further include: a control unit that generates a first control signal for controlling the timing signal that is output from the first circuit, a second control signal for controlling the timing signal that is output from the second circuit, the timing signal, the first data signal, and the second data signal, outputs the first control signal, the timing signal, and the first data signal to the first circuit, and outputs the second control signal, the timing signal, and the second data signal to the second circuit, in which the first circuit output the timing signal to the electro-optical panel based on the first control signal, and the second circuit output the timing signal to the electro-optical panel based on the second control signal.

According to the application example, outputting of the timing signal from the first circuit is controlled by the first control signal supplied from the control unit to the first circuit, and outputting of the timing signal from the second circuit is controlled by the second control signal supplied from the control unit to the second circuit. In addition, the first data signal and the timing signal are also supplied from the control unit to the first circuit, and the second data signal and the timing signal are also supplied from the control unit to the second circuit.

Accordingly, it is possible to collectively transmit these signals from the control unit to the first circuit and the second circuit by, for example, a low voltage differential signaling (LVDS) method (small amplitude differential signal method), and it is possible to provide the electro-optical device in which a transmission path of various signals is simplified.

### Application Example 6

In the electro-optical device according to the application example, it is preferable that the first circuit and the second circuit be integrated circuits, the first circuit be provided on a first flexible printed circuit, and the second circuit be provided on a second flexible printed circuit.

According to the application example, the first circuit and the second circuit are electrically connected to the electro-optical panel through the wires of respective flexible printed circuits, and thus it is possible to provide the electro-optical device in which simplification of a configuration is realized.

### Application Example 7

According to the application example, it is preferable that an electronic apparatus include the electro-optical device according to the application example.

According to the application example, by reducing the difference in the output characteristics of the first circuit and the second circuit, since the visibility of luminance unevenness is reduced, it is possible to provide the electronic apparatus capable of good-looking displaying.

### Application Example 8

According to this application example, there is provided a control method of an electro-optical device including an electro-optical panel in which a first pixel group and a second pixel group configured by a pixel corresponding to an intersection of a data line and a scan line, and a driving circuit for writing a first data signal to the first pixel group and writing a second data signal to the second pixel group are provided; a first circuit that can output the first data signal and a timing signal for controlling the driving circuit to the electro-optical panel; and a second circuit that can output the second data signal and the timing signal to the electro-optical panel, the method includes controlling the number of times that the first circuit outputs the timing signal in a state where the second circuit stops outputting the timing signal to be equalized with the number of times that the second circuit outputs the timing signal in a state where the first circuit stops outputting the timing signal, during one horizontal scanning period during which writing to the pixel connected to at least one scan line is performed.

According to the application example, during one horizontal scanning period during which writing to the pixel connected to one scan line is performed, it is possible to equalize driving loads of the timing signal of each integrated circuit. With this, for example, if the first circuit and the second circuit are the data line driving circuits, it is possible to reduce the difference in the amount of generated heat of each data line driving circuit as compared to the related art. Accordingly, it is possible to reduce the difference in the output characteristics between the respective data line driving circuits, and thus the visibility of luminance unevenness is reduced.

That is, it is possible to provide a control method of an electro-optical device reducing the visibility of luminance unevenness due to the difference of loads between respective integrated circuits (for example, data line driving circuit). In this embodiment, for example, the “driving circuit” may be the distribution circuit (demultiplexer), and the first circuit and the second circuit may be the data line driving circuit. In addition, in a case where the “driving circuit” is the distribution circuit (demultiplexer), the “timing signal” may be a selection signal for operating the distribution circuit (demultiplexer).

### Application Example 9

According to the application example, it is preferable that the control method of an electro-optical device further include: controlling the first circuit to output the timing signal to the first pixel in the first pixel group, and to write the first data signal corresponding to the first pixel to the first pixel, controlling the first data signal corresponding to the second pixel to be written to the second pixel adjacent to the first pixel in the first pixel group in a first direction parallel with or orthogonal to the scan line in a state where the first circuit stops outputting the timing signal, and controlling the first data signal corresponding to a third pixel to be written to the third pixel adjacent to the first pixel in the first pixel group in a direction opposite to the first direction in the state where the first circuit stops outputting the timing signal.

According to the application example, it is possible to prevent the pixels to which the data signal changed by outputting the timing signal is written, from being adjacent to each other. As a result, for example, when the full-screen same gradation is displayed, since it is possible to arrange the pixel by being distributed within a screen, it is possible to reduce the difference of average values of the luminance for a partial region within the screen. That is, the visibility of luminance unevenness is further reduced.

### BRIEF DESCRIPTION OF THE DRAWINGS

The invention will be described with reference to the accompanying drawings, wherein like numbers reference like elements.

FIG. 1 is a perspective view illustrating a configuration example of the main part of an electro-optical device of an embodiment 1.

FIG. 2 is a diagram illustrating a circuit configuration of a display unit.

FIG. 3 is a diagram of a pixel circuit.

FIG. 4 is a diagram for explaining an operation of the electro-optical device.

FIG. 5 is a diagram for explaining a configuration of supplying selection signals to the display unit.

FIG. 6 is a diagram for explaining a timing according to the outputting of selection signals from first and fourth data line driving circuits.

FIG. 7 is a diagram for explaining how to see luminance unevenness of the related art.

FIG. 8 is a diagram for explaining how to see luminance unevenness of the embodiment 1.

FIG. 9 is a diagram for explaining a modification example of the embodiment 1.

FIG. 10 is a diagram for explaining an application example of the embodiment 1.

FIG. 11 is a schematic view illustrating a configuration of a projection type display apparatus as an electronic apparatus.

### DESCRIPTION OF EXEMPLARY EMBODIMENTS

Hereinafter, embodiments of the present invention will be described with reference to the drawings. In the following drawings, in order to make each layer and each member to be a recognizable size, a scale of each layer and each member is different from an actual scale.

An electro-optical device described in the present embodiment can be suitably used in an optical modulator (light valve) in a projection type display apparatus (liquid crystal projector) as an electronic apparatus which will be described below, and is an active drive type liquid crystal display apparatus. The projection type display apparatus (liquid crystal projector) is an apparatus that enlarges and projects an image displayed by the liquid crystal display apparatus with respect to a projected object such as a screen. Accordingly, as compared to a case of directly looking at this, since luminance unevenness or the like is more likely to be visually recognized, the liquid crystal display apparatus used as the optical modulator is required to be able to realize higher display quality.

### Embodiment 1

### Electro-Optical Device

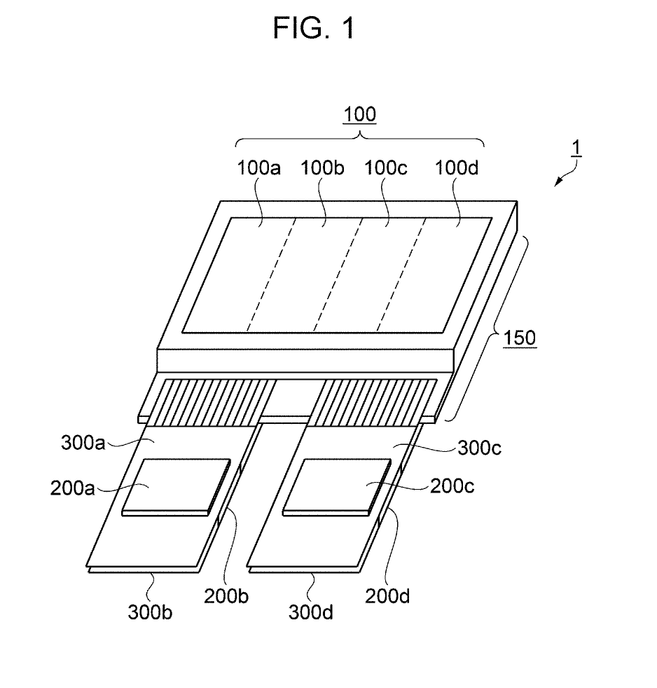

FIG. 1 is a perspective view illustrating a configuration example of a main part of the electro-optical device. As illustrated in FIG. 1, an electro-optical device 1 of the present embodiment includes an electro-optical panel 150 including a display unit 100, a first flexible printed circuit (hereinafter, referred to as first FPC) 300a on which a first data line driving circuit 200a is mounted, a second flexible printed circuit (hereinafter, referred to as second FPC) 300b on which a second data line driving circuit 200b is mounted, a third flexible printed circuit (hereinafter, referred to as third FPC) 300c on which a third data line driving circuit 200c is mounted, and a fourth flexible printed circuit (hereinafter, referred to as fourth FPC) 300d on which a fourth data line driving circuit 200d is mounted. Each of the first data line driving circuit 200a to the fourth data line driving circuit 200d is configured with, for example, an integrated circuit (IC) of one chip, and mounted on each of the first FPC 300a to the fourth FPC 300d by a chip on film (COF) technology.

A display region in the display unit 100 is divided into a first region 100a, a second region 100b, a third region 100c, and a fourth region 100d.

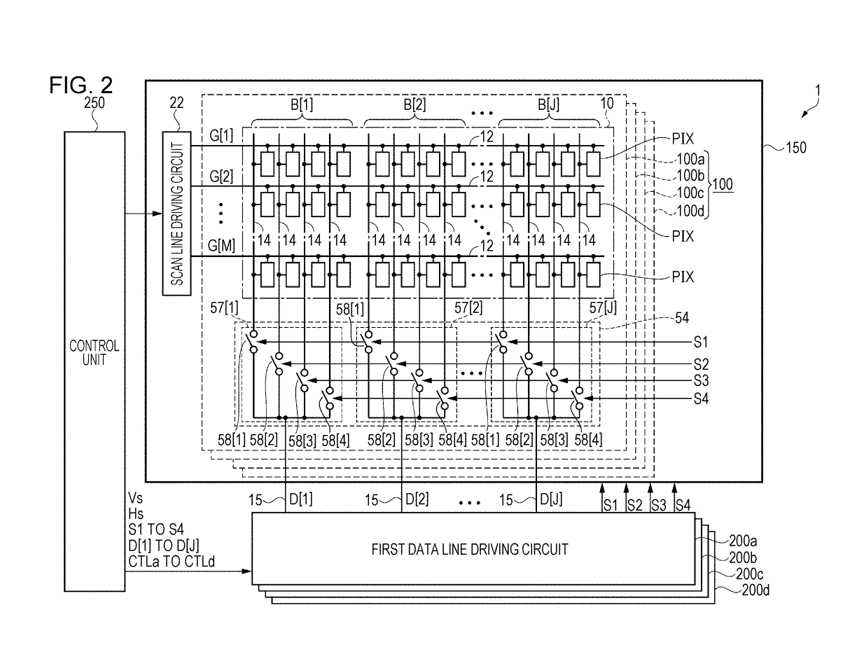

Wires (not illustrated) for transmitting signals are provided in the first FPC 300a to the fourth FPC 300d, and a signal input terminal (not illustrated; corresponding to first terminal and second terminal of the invention) in the electro-optical panel 150 is connected to one end portion of the wire. In addition, the other end portion of the wire is connected to a substrate (not illustrated), and a control unit 250 (see FIG. 2) is provided on the substrate. That is, the first data line driving circuit 200a to the fourth data line driving circuit 200d are electrically connected to the electro-optical panel 150 and the control unit 250 (see FIG. 2) through the wires of the first FPC 300a to the fourth FPC 300d. The first data line driving circuit 200a is an example of a “first circuit” according to the invention, and the second data line driving circuit 200b to the fourth data line driving circuit 200d are examples of a “second circuit” of the invention. In addition, when the second data line driving circuit 200b is set to an example of the “first circuit” of the invention, the first data line driving circuit 200a, the second data line driving circuit 200b, or the fourth data line driving circuit 200d is an example of the “second circuit” of the invention.

FIG. 2 is a diagram illustrating a circuit configuration of the display unit 100. Since each of the first region 100a to the fourth region 100d adopts the same configuration, redundant description is omitted. Here, a configuration of the first region 100a will be described below.

M scan lines 12 and N data lines 14 which are intersected with each other are formed in a pixel unit 10 (M and N are natural numbers equal to or greater than two). In addition, pixel circuits PIX corresponding to the intersection of the scan line 12 and the data line 14 are arranged in the pixel unit 10. That is, the pixel circuits PIX are arranged in a matrix of M rows in a vertical direction×N columns in a horizontal direction.

As illustrated in FIG. 2, the pixel circuits PIX inside the pixel unit 10 are divided into J pixel blocks B[1] to B[J]. Specifically, N data lines 14 inside the pixel unit 10 are connected to the same distribution circuits 57 [j (j is arbitrary natural number satisfying 1≦j≦J)] for 4 data lines which are continuously arranged, and a set of the pixel circuit PIX connected to the same distribution circuit 57[j] is set to one pixel block B[j]. A relationship of J=N/4 is established.

The distribution circuits 57[1] to 57[J] are connected to the first data line driving circuit 200a by J control lines 15 corresponding to each of the pixel blocks B[1] to B[J].

The j-th distribution circuit 57[j] is a circuit (demultiplexer) that distributes an image signal D[j] supplied to the j-th control line 15 to each of four data lines 14 corresponding to the pixel block B[j], and configured to include four switches 58[1] to 58[4] of the data lines 14 corresponding to the pixel block B[j]. The x-th switch 58[x] of the distribution circuit 57[j] is interposed between the x-th data line 14 among four data lines 14 and the j-th control line 15 among j control lines 15 of the pixel block B[j], and controls electric connection (conduction/non-conduction) therebetween.

Here, a set of the pixel circuit PIX driven by the first data line driving circuit 200a is referred to as a “first pixel group”, a set of the pixel circuit PIX driven by the second data line driving circuit 200b is referred to as a “second pixel group”, a set of the pixel circuit PIX driven by the third data line driving circuit 200c is referred to as a “third pixel group”, and a set of the pixel circuit PIX driven by the fourth data line driving circuit 200d is referred to as a “fourth pixel group”. That is, a plurality of pixel blocks B[j] are included in the first pixel group to the fourth pixel group, respectively. Specifically, in the present embodiment, all of the pixel blocks B[1] to B[J] of the first region 100a are included in the first pixel group, a pixel block of the second region 100b is totally included in the second pixel group, a pixel block of the third region 100c is totally included in the third pixel group, and all of the pixel blocks B[1] to B[J] of the fourth region 100d are included in the fourth pixel group.

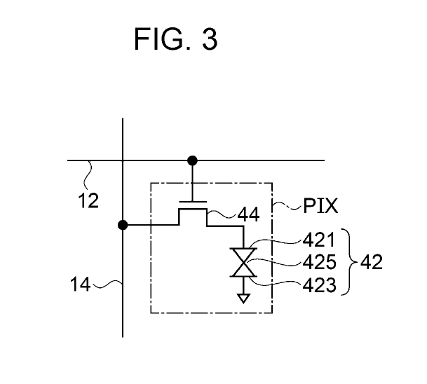

FIG. 3 is a circuit diagram of each pixel circuit PIX. As illustrated in FIG. 3, each pixel circuit PIX is configured to include a liquid crystal element 42 and a selection switch 44. The liquid crystal element 42 is an electro-optical element in which a pixel electrode 421 and a common electrode 423 which are facing each other and a liquid crystal 425 between both electrodes are configured. Transmittance of the liquid crystal 425 changes according to an apply voltage between the pixel electrode 421 and the common electrode 423. For convenience in the following description, in a case where an electric level of the pixel electrode 421 is higher than that of the common electrode 423, a voltage applied to the liquid crystal element 42 is denoted as positive polarity, and in a case where an electric level of the pixel electrode 421 is lower than that of the common electrode 423, a voltage applied to the liquid crystal element 42 is denoted as negative polarity.

The selection switch 44 is configured by an N-channel thin film transistor of which a gate is connected to the scan line 12, and controls electric connection (conduction/non-conduction) of both by interposing the liquid crystal element 42 (pixel electrode 421) and the data line 14. Accordingly, the pixel circuit PIX (liquid crystal element 42) indicates gradation (gradation in accordance with image signal D[j]) in accordance with a potential of the data line 14 when the selection switch 44 is controlled in a turn-on state. An illustration of an auxiliary capacitor connected in parallel with the liquid crystal element 42 and the like is omitted.

Description returns to FIG. 2. For example, the control unit 250 outputs a signal of a digital transmission method referred to as low voltage differential signaling (LVDS). For example, a vertical synchronization signal Vs, a horizontal synchronization signal Hs, selection signals S1 to S4, image signals D[1] to D[J], control signals CTLa to CTLd, and the like are included in signals of a LVDS method output from the control unit 250. The control unit 250 controls the first data line driving circuit 200a to the fourth data line driving circuit 200d by supplying various signals.

In addition, the control unit 250 generates four selection signals S1 to S4 corresponding to the number of the data lines 14 in each pixel block B[j], and supplies the generated signals to the first data line driving circuit 200a to the fourth data line driving circuit 200d. The selection signals S1 to S4 are timing signals for controlling a timing of writing the data signal by the above-described J distribution circuits 57[1] to 57[J].

Here, each of J distribution circuits 57[1] to 57[J] includes four switches 58[1] to 58[4]. Each of the switches 58[1] to 58[4] includes a control input terminal (not illustrated) to which a signal (selection signals S1 to S4) for controlling turn-on and turn-off thereof is input, and is switched between the turn-on and turn-off by a signal level that is input to the control input terminal (not illustrated). That is, the distribution circuits 57[1] to 57[J] function as a driving circuit for writing the data signal in a predetermined pixel group, and are examples of a first selection circuit and a second selection circuit in the invention.

Here, a selection signal S1 is supplied in parallel to control input terminals (not illustrated) of the first switch 58[1] (J switches 58[1] in signal distribution circuit 54) in each of J distribution circuits 57[1] to 57[J], and is a signal for controlling the turn-on and turn-off of the switch 58[1]. Similarly, a selection signal S2 is supplied to control input terminals (not illustrated) of the second switch 58[2], and is a signal for controlling the turn-on and turn-off of the switch 58[2]. A selection signal S3 is supplied to control input terminals (not illustrated) of the third switch 58[3], and is a signal for controlling the turn-on and turn-off of the switch 58[3], and a selection signal S4 is a signal for controlling the turn-on and turn-off of the fourth switch 58[4]. That is, the selection signal S1 controls writing in the x-th column, the selection signal S2 controls writing in the (x+1)-th column, the selection signal S3 controls writing in the (x+2)-th column, and the selection signal S4 controls writing in the (x+3)-th column.

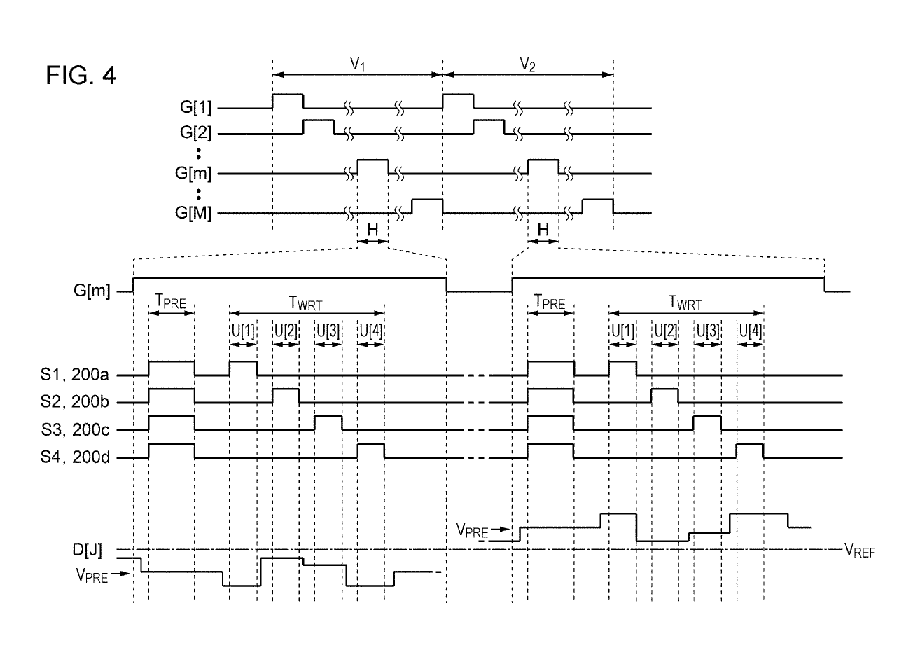

FIG. 4 is a diagram for explaining an operation of the electro-optical device 1. As illustrated in FIG. 4, the control unit 250 supplies an image signal D[J] of which the polarity of the voltage applied to the liquid crystal element 42 is reversed for each vertical scanning period (in vertical scanning period V₁ and vertical scanning period V₂ of FIG. 4) to the first data line driving circuit 200a to the fourth data line driving circuit 200d.

As illustrated in FIG. 4, a scan signal G[m] supplied to the scan line 12 of the m-th (m is natural number of 1≦m≦M) row is set to a high level (potential meaning selection of scan line 12) during the m-th horizontal scanning period H among the M horizontal scanning periods H within each vertical scanning period V. When a scan line driving circuit 22 selects the scan line 12 of the m-th row, each selection switch 44 of N pixel circuits PIX of the m-th row transitions from a turn-off state to a turn-off state.

The first data line driving circuit 200a controls a potential of each of the N data lines 14 in synchronization with selection in each scan line 12 by the scan line driving circuit 22. As illustrated in FIG. 2, the first data line driving circuit 200a supplies in parallel the image signals D[1] to D[J] of J lines corresponding to the pixel blocks B[1] to B[J] to each control line 15.

Description returns to FIG. 4. Each horizontal scanning period H during which the scan line driving circuit 22 selects the scan line 12 is configured to include a precharge period T_{PRE} and a writing period T_{WRT}. In the example illustrated in FIG. 4, a structure in which the precharge period T_{PRE} is provided during all of the horizontal scanning period H, or the precharge period T_{PRE} is provided during one or more horizontal scanning period H, may be used. In addition, in the example illustrated in FIG. 4, in order to focus on a characteristic part of the present embodiment while avoiding complication of drawing, a post charge period during which a so-called post charge potential is supplied to each control line 15 within the horizontal scanning period H is not provided. However, it is of course also possible to provide the post charge period within the horizontal scanning period H. The post charge period is a period for writing a predetermined post charge potential in the line 15 to prevent the potential between the pixel electrode 421 and the common electrode 423 from varying between pixels at the beginning of the next horizontal scanning period H.

The reference numerals in parentheses immediately after the selection signals S1 to S4 indicate the reference numerals of the data line driving circuits that output the selection signals S1 to S4. That is, in the example illustrated in FIG. 4, in each of the vertical scanning periods V₁ and V₂, first, during the precharge period T_{PRE} within one horizontal scanning period H, the first data line driving circuit 200a outputs the selection signal S1, the second data line driving circuit 200b outputs the selection signal S2, the third data line driving circuit 200c outputs the selection signal S3, and the fourth data line driving circuit 200d outputs the selection signal S4 at the same time (set to active level). In other words, each data line driving circuit sets each selection signal to the active level during the precharge period T_{PRE} within the horizontal scanning period H.

At this time, in the precharge period T_{PRE} within each one horizontal scanning period H, all of the switches 58[1] to 58[4] transition to a turn-on state within the signal distribution circuit 54, and the precharge potential V_{PRE} is supplied to each (furthermore, pixel electrode 421 within each pixel circuit PIX) of the N data lines 14.

As described above, since each potential of each data line 14 is initialized to the precharge potential V_{PRE} before supply (before writing) of the image signal D[J] with respect to each pixel circuit PIX, the gradation unevenness (vertical crosstalk) of a display image can be prevented.

Here, the precharge potential V_{PRE} is set to a negative or positive potential for each vertical scanning period with respect to a predetermined reference potential V_{REF} (for example, potential which is amplitude center of image signal D[J]).

Similarly, during the writing period T_{WRT} within each one horizontal scanning period H, the first data line driving circuit 200a outputs the selection signal S1, the second data line driving circuit 200b outputs the selection signal S2, the third data line driving circuit 200c outputs the selection signal S3, and the fourth data line driving circuit 200d outputs the selection signal S4 sequentially (set to active level). Accordingly, in each unit period U [k (k is natural number satisfying 1≦k≦4)] within the horizontal scanning period H during which the scan line 12 of the m-th row is selected, the k-th switch 58[k] (total J switches 58[k] within signal distribution circuit 54) among four switches 58[1] to 58[4] in each of the distribution circuits 57[1] to 57[J] transitions to a turn-on state, a gradation potential of the image signal D[J] is supplied to the data line 14 of the k-th column of each pixel block B[j].

That is, during the writing period T_{WRT}, the gradation potential is supplied to four data lines 14 within the pixel block B[j] in each of J pixel blocks B[1] to B[J] in a time division manner. In a unit period U[k] within the m-th horizontal scanning period H, the gradation potential is set based on designation gradation of the pixel circuit PIX corresponding to an intersection of the scan line 12 of the m-th row and the data line 14 of the k-th column within the pixel block B[j].

As described above, in the example illustrated in FIG. 4, outputting of all of the data line driving circuits is performed twice in total of once during the precharge period T_{PRE} and once during the writing period T_{WRT}. That is, in one horizontal scanning period during which writing is performed in a pixel connected to one scan line 12, driving loads of the selection signals of the respective data line driving circuits can be equalized. That is, as compared to the related art (method of equalizing the number of times that selection signals are output in each data line driving circuit during a plurality of horizontal scanning periods), it is possible to reduce difference in the amount of generated heat of each data line driving circuit and to reduce difference in the output characteristics between the respective data line driving circuits.

As described above, with reference to FIG. 2 to FIG. 4, the first region 100a among the first region 100a to the fourth region 100d configuring the display unit 100 of the electro-optical panel 150 is described. However, the second region 100b driven by the second data line driving circuit 200b, the third region 100c driven by the third data line driving circuit 200c, and the fourth region 100d driven by the fourth data line driving circuit 200d are also configured and operated similarly to the first region 100a. In addition, driving methods of the second region 100b to the fourth region 100d by the second data line driving circuit 200b to the fourth data line driving circuit 200d are the same as driving methods of the first region 100a by the first data line driving circuit 200a.

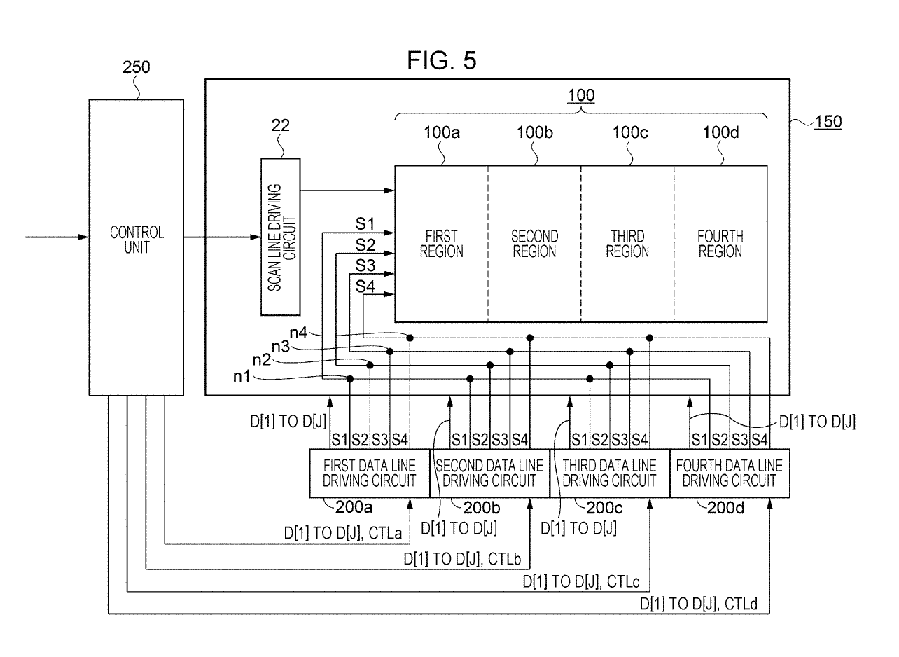

FIG. 5 is a diagram for explaining a configuration of supplying the selection signals S1 to S4 to the electro-optical panel 150. The selection signals S1 to S4 generated by the control unit 250 are output to the first data line driving circuit 200a to the fourth data line driving circuit 200d. Accordingly, through controlling by the control unit 250, one circuit among the first data line driving circuit 200a to the fourth data line driving circuit 200d outputs the selection signals S1 to S4 to J distribution circuits 57 [1] to 57[J].

As illustrated in FIG. 5, supply paths of the selection signals S1 from the first data line driving circuit 200a to the fourth data line driving circuit 200d are connected to each other at a node n1 on a transmission path of the selection signal S1 within the electro-optical panel 150. Supply paths of the selection signals S2 from the first data line driving circuit 200a to the fourth data line driving circuit 200d are connected to each other at a node n2 on a transmission path of the selection signal S2 within the electro-optical panel 150. Supply paths of the selection signals S3 from the first data line driving circuit 200a to the fourth data line driving circuit 200d are connected to each other at a node n3 on a transmission path of the selection signal S3 within the electro-optical panel 150. Supply paths of the selection signals S4 from the first data line driving circuit 200a to the fourth data line driving circuit 200d are connected to each other at a node n4 on a transmission path of the selection signal S4 within the electro-optical panel 150.

### Control Method of Electro-Optical Device

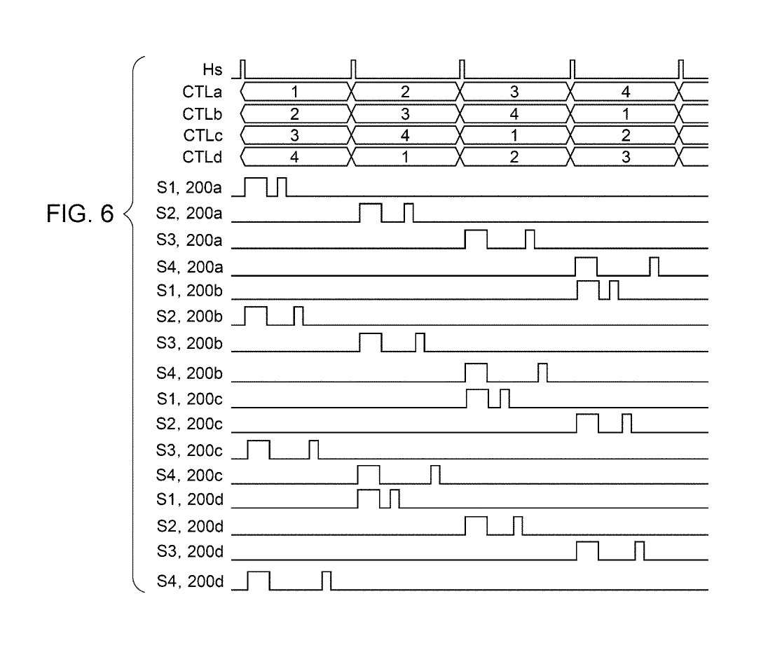

FIG. 6 is a diagram for explaining a control method of a timing during which the selection signals S1 to S4 are output to the first data line driving circuit 200a to the fourth data line driving circuit 200d. In FIG. 6, the reference numerals in parentheses immediately after the selection signals S1 to S4 indicate the reference numerals of the data line driving circuits that output the selection signals S1 to S4.

In the present embodiment as described above, in the same one horizontal scanning period H, the control unit 250 controls the number of times of the selection signals output from the first data line driving circuit 200a to the fourth data line driving circuit 200d to be the same number (twice). In addition, the number of times of the data signals output from the first data line driving circuit 200a to the fourth data line driving circuit 200d is controlled to be the same number. With this, it is possible to reduce the difference in the amount of generated heat in each data line driving circuit, and it is possible to reduce differences in output characteristics between respective data line driving circuits. The control unit 250 is controlled by supplying a control signal CTLa to the first data line driving circuit 200a, supplying a control signal CTLb to the second data line driving circuit 200b, supplying a control signal CTLc to the third data line driving circuit 200c, and supplying a control signal CTLd to the fourth data line driving circuit 200d. The control signal CTLa is an example of the first control signal of the invention, and the control signal CTLb is an example of the second control signal of the invention. In addition, the number of times of the selection signals output from the first data line driving circuit 200a is an example of the number of times that timing signals are output from the first circuit of the invention, and the number of times of the selection signals output from the second data line driving circuit 200b is an example of the number of times that timing signals are output from the second circuit of the invention. In addition, the data signal output from the first data line driving circuit 200a is an example of the first data signal of the invention, and the data signal output from the second data line driving circuit 200b is an example of the second data signal of the invention.

Specifically, in a case where a value indicated by the control signals CTLa to CTLd is “1”, the selection signal S1 is controlled, in a case of “2”, the selection signal S2 is controlled, in a case of “3”, the selection signal S3 is controlled, and in a case of “4”, the selection signal S4 is controlled.

On the other hand, the first data line driving circuit 200a to the fourth data line driving circuit 200d set an output stage of the selection signals S1 to S4 to active, output the selection signals S1 to S4, and supply the output selection signals to the electro-optical panel 150 in a state where the control signals CTLa to CTLd set to the active level are supplied.

A specific output state of the selection signals S1 to S4 during the precharge period T_{PRE} and the writing period T_{WRT} is the same as the state described with reference to FIG. 4.

In an example illustrated in FIG. 6, the control unit 250 outputs the horizontal synchronization signal Hs and sets the control signals CTLa to CTLd to values in accordance with the selection signals S1 to S4 to be output. Here, the control unit 250 switches sequentially values of the control signals CTLa to CTLd in accordance with the selection signals S1 to S4 for each one horizontal scanning period H. Specifically, as illustrated in FIG. 6, the values indicated by the control signals CTLa to CTLd are sequentially switched as 1→2→3→4 for each one horizontal scanning period H.

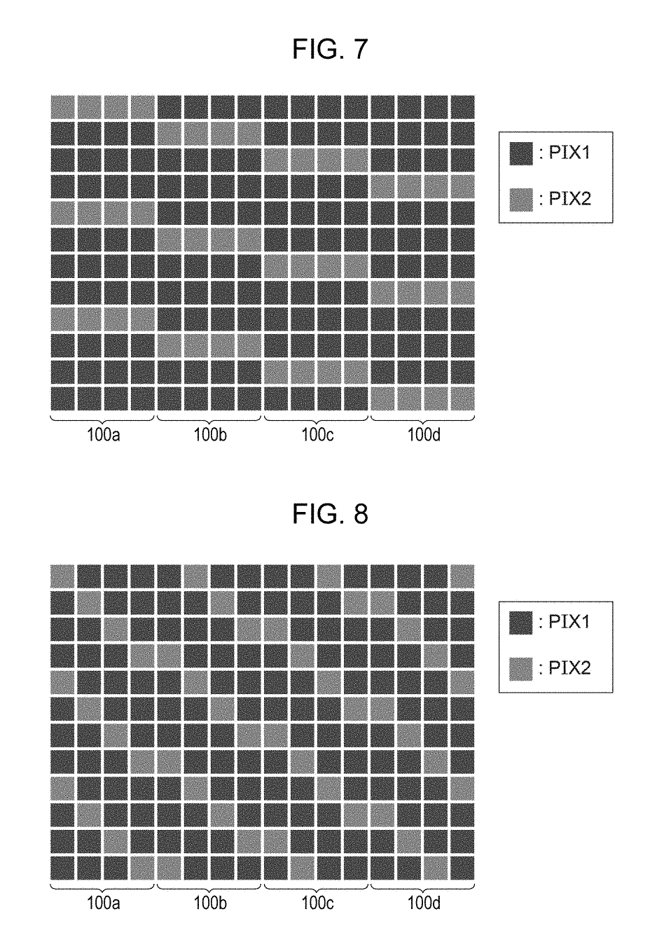

FIG. 7 is an image diagram of a screen projected image when full-screen same gradation is displayed on the display unit 100 based on the outputting of the selection signals S1 to S4 described in the related art (JP-A-2015-232590). Specifically, it is the screen projected image when it is projected using the projection type display device including the electro-optical device 1 which will be described below. Here, when focusing on the first region 100a, a screen in which a pixel PIX1 to which the selection signals S1 to S4 and the first data signal output from the first data line driving circuit 200a are written and a pixel PIX2 to which the first data signal output from the first data line driving circuit 200a is written without the selection signals S1 to S4 output from the first data line driving circuit 200a is present. Since luminances of those pixels are different from each other, the luminances are visually recognized as luminance unevenness.

Meanwhile, FIG. 8 is an image diagram of the screen projected image when the full-screen same gradation is displayed on the display unit 100 based on outputting of the selection signals S1 to S4 in the present embodiment illustrated in FIG. 6. Here, when focusing on the first region 100a, the pixel PIX1 to which the selection signals S1 to S4 and the first data signal output from the first data line driving circuit 200a are written, is arranged to be adjacent to the pixel PIX2 to which the first data signal output from the first data line driving circuit 200a is written without the selection signals S1 to S4 output from the first data line driving circuit 200a, each other in the vertical direction and the lateral direction. With this, as compared to the screen projected image of the related art illustrated in FIG. 7, since it is possible to arrange the pixel PIX2 to which the first data signal of which characteristics have changed by being distributed within a screen is written, it is possible to reduce the difference of average values of the luminance for a partial region within the screen. That is, it is possible to reduce the visibility of the luminance unevenness. The pixel PIX1 to which the selection signals S1 to S4 and the first data signal output from the first data line driving circuit 200a are written is an example of the “first pixel” according to the invention, and the pixel PIX2 to which the first data signal output from the first data line driving circuit 200a is written without the selection signals S1 to S4 output from the first data line driving circuit 200a is an example of the “second pixel” or the “third pixel” of the invention. In FIG. 8, for example, a direction from the left to the right in a row in which the pixels PIX1 and PIX2 are arranged is an example of the first direction of the invention. Alternately, for example, a direction from the top to the bottom in a column may be an example of the first direction. In addition, here, although focusing on the first region 100a, the pixel PIX1 and the pixel PIX2 also have the same relationship with respect to the second region 100b to the fourth region 100d.

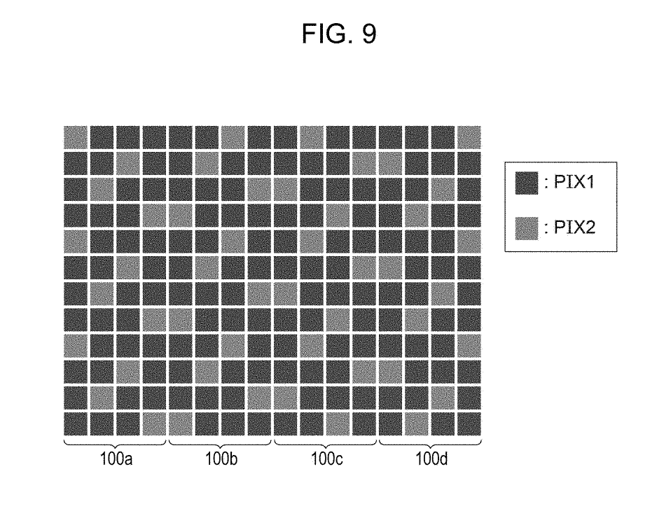

In addition, the above-described embodiment, values indicated by the control signals CTLa to CTLd are sequentially switched as 1→2→3→4 for each one horizontal scanning period H. However, the invention is not limited thereto. For example, the values indicated by the control signals CTLa to CTLd may be sequentially switched as 1→3→2→4. Thus, as illustrated in FIG. 9, since it is possible to arrange pixels in which data signals of which characteristics are changed by being dispersed in a plane are written, it is possible to further reduce the visibility of luminance unevenness.

As described above, in the present embodiment, as compared to a configuration in which only one specific data line driving circuit among the first data line driving circuit 200a to the fourth data line driving circuit 200d outputs the selection signals S1 to S4 during one the horizontal scanning period H, since it is possible to uniform loads of the first data line driving circuit 200a to the fourth data line driving circuit 200d, it is suppressed that difference in output characteristics between respective data line driving circuits occurs.

### Modification Example 1

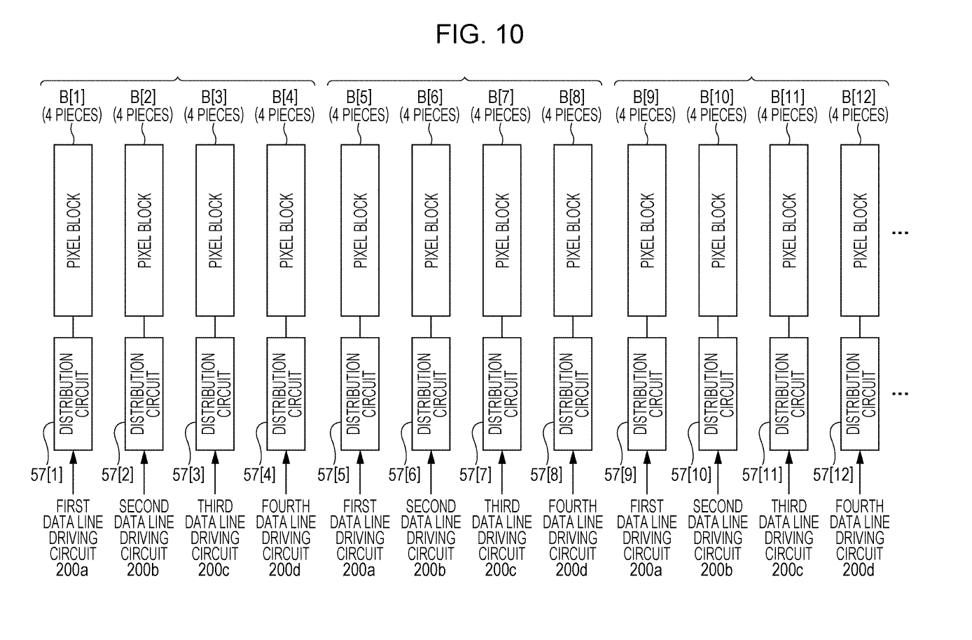

In the above-described embodiment, for convenience of explanation, the display unit 100 is driven by associating each region of the first region 100a to the fourth region 100d of the display unit 100 with each data line driving circuit of the first data line driving circuit 200a to the fourth data line driving circuit 200d one by one. However, the invention is not limited such a driving state. For example, as illustrated in FIG. 10, in an order of decreasing a value of “j” of the pixel block B[j], that is, in an order of driving by the first data line driving circuit 200a→driving by the second data line driving circuit 200b→driving by the third data line driving circuit 200c→driving by the fourth data line driving circuit 200d→driving by the first data line driving circuit 200a→, . . . , the first data line driving circuit 200a to the fourth data line driving circuit 200d may be allocated as the data line driving circuit of each pixel block [j].

Accordingly, when x is an integer equal to or greater than zero, in the present modification example, the pixel block B[4x+1] is the first pixel group driven by the first data line driving circuit 200a, the pixel block B[4x+2] is the second pixel group driven by the second data line driving circuit 200b, the pixel block B[4x+3] is the third pixel group driven by the third data line driving circuit 200c, and the pixel block B[4x+4] is the fourth pixel group driven by the fourth data line driving circuit 200d.

### Modification Example 2

In the above-described embodiment, the liquid crystal display apparatus is described as an example of the electro-optical device. For example, the above-described embodiment can be applied to a display apparatus of another type such as an organic electroluminescence display (OLED).

### Embodiment 2

### Electronic Apparatus

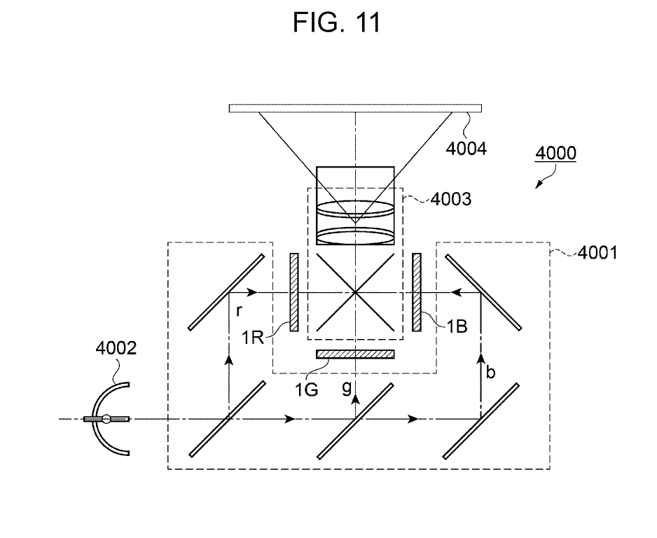

An example of an electronic apparatus to which the electro-optical device 1 according to the embodiment 1 is applied will be described with reference to FIG. 11. FIG. 11 is a schematic diagram of the projection type display apparatus (three-plate type liquid crystal projector) as the electronic apparatus. A projection type display apparatus 4000 as the electronic apparatus of the present embodiment is configured to include three electro-optical devices 1 (1R, 1G, and 1B) corresponding to different display colors (red, green, and blue). An illumination optical system 4001 supplies a red component r of light beams emitted from a lighting device (light source) 4002 to the electro-optical device 1R, supplies a green component g to the electro-optical device 1G, and supplies a blue component b to the electro-optical device 1B. Each of the electro-optical devices 1 functions as an optical modulator (light valve) that modulates each monochromatic light beam supplied from the illumination optical system 4001 according to a display image. A projection optical system 4003 synthesizes the light beams emitted from each electro-optical device 1 and projects the synthesized light beams on a projection surface 4004 such as a screen.

According to the projection type display apparatus 4000, since the electro-optical device 1 is used as the optical modulator (light valve), it is possible to provide the projection type display apparatus 4000 which can project a display with a good appearance in which luminance unevenness is reduced. The electronic apparatus to which the electro-optical device 1 is applied is not limited to the projection type display apparatus 4000, but can be applied to, for example, a head-mounted display (HMD), a head-up display (HUD), or the like.

The entire disclosure of Japanese Patent expressly incorporated by reference herein.

What is claimed is:

1. An electro-optical device comprising:
an electro-optical panel in which a first pixel group and a second pixel group configured by pixels corresponding to an intersection of a data line and a scan line, and a driving circuit for writing a first data signal to the first pixel group and writing a second data signal to the second pixel group are provided;
a first circuit that can output the first data signal and a timing signal, and the timing signal control the driving circuit to the electro-optical panel; and
a second circuit that can output the second data signal and the timing signal to the electro-optical panel,
wherein during one horizontal scanning period, the number of times that the first circuit outputs the timing signal in a state where the second circuit stops outputting the timing signal is equal to the number of times that the second circuit outputs the timing signal in a state where the first circuit stops outputting the timing signal.

2. The electro-optical device according to claim 1,
wherein the first circuit outputs the timing signal to a first pixel in the first pixel group, and the first data signal corresponding to the first pixel is written to the first pixel,
the first data signal corresponding to a second pixel is written to the second pixel adjacent to the first pixel in the first pixel group in a first direction parallel with or orthogonal to the scan line in a state where the first circuit stops outputting the timing signal, and
the first data signal corresponding to a third pixel is written to the third pixel adjacent to the first pixel in the first pixel group in a direction opposite to the first direction in the state where the first circuit stops outputting the timing signal.

3. The electro-optical device according to claim 1,
wherein the electro-optical panel includes
a first terminal to which the timing signal is supplied from the first circuit,
a second terminal to which the timing signal is supplied from the second circuit, and
a wire that electrically connects the first terminal, the second terminal, and the driving circuit to one another.

4. The electro-optical device according to claim 1,
wherein the driving circuit includes
a first selection circuit that outputs the first data signal to one data line selected among N (N is a natural number equal to or greater than two) data lines belonging to the first pixel group based on the timing signal, and
a second selection circuit that outputs the second data signal to one data line selected among N data lines belonging to the second pixel group based on the timing signal.

5. The electro-optical device according to claim 1, further comprising:
a control unit that generates a first control signal for controlling the timing signal that is output from the first circuit, a second control signal for controlling the timing signal that is output from the second circuit, the timing signal, the first data signal, and the second data signal, outputs the first control signal, the timing signal, and the first data signal to the first circuit, and outputs the second control signal, the timing signal, and the second data signal to the second circuit,
wherein the first circuit outputs the timing signal to the electro-optical panel based on the first control signal, and
the second circuit outputs the timing signal to the electro-optical panel based on the second control signal.

6. The electro-optical device according to claim 1,
wherein the first circuit and the second circuit are integrated circuits,
the first circuit is provided on a first flexible printed circuit, and
the second circuit is provided on a second flexible printed circuit.

7. An electronic apparatus comprising:
the electro-optical device according to claim 1.

8. An electronic apparatus comprising:
the electro-optical device according to claim 2.

9. An electronic apparatus comprising:
the electro-optical device according to claim 3.

10. An electronic apparatus comprising:
the electro-optical device according to claim 4.

11. An electronic apparatus comprising:
the electro-optical device according to claim 5.

12. An electronic apparatus comprising:
the electro-optical device according to claim 6.

13. A control method of an electro-optical device including an electro-optical panel in which a first pixel group and a second pixel group configured by a pixel corresponding to an intersection of a data line and a scan line, and a driving circuit for writing a first data signal to the first pixel group and writing a second data signal to the second pixel group are provided; a first circuit that can output the first data signal and a timing signal for controlling the driving circuit to the electro-optical panel; and a second circuit that can output the second data signal and the timing signal to the electro-optical panel, the method comprising:
controlling the number of times that the first circuit outputs the timing signal in a state where the second circuit stops outputting the timing signal to be equalized with the number of times that the second circuit outputs the timing signal in a state where the first circuit stops outputting the timing signal, during one horizontal scanning period during which writing to the pixel connected to at least one scan line is performed.

14. The control method of an electro-optical device according to claim 13, further comprising:
controlling the first circuit to output the timing signal to a first pixel in the first pixel group, and to write the first data signal corresponding to the first pixel to the first pixel;
controlling the first data signal corresponding to a second pixel to be written to the second pixel adjacent to the first pixel in the first pixel group in a first direction parallel with or orthogonal to the scan line in a state where the first circuit stops outputting the timing signal; and
controlling the first data signal corresponding to a third pixel to be written to the third pixel adjacent to the first pixel in the first pixel group in a direction opposite to the first direction in the state where the first circuit stops outputting the timing signal.

15. The electro-optical device according to claim 1,
wherein the first pixel group includes
a first pixel,
a second pixel that is adjacent to the first pixel in a first direction parallel with or orthogonal to the scan line, and
a third pixel that is adjacent to the first pixel in a direction opposite to the first direction,
during a first period in which the first circuit outputs the timing signal, the first data signal is written to the first pixel,
during a second period in which the first circuit stops outputting the timing signal, the first data signal is written to the second pixel and third pixel.
